(19) United States
(12) Patent Application Publication
(10) Pub. No.: US 2012/0292080 A1
(43) Pub. Date: Nov. 22, 2012

(54) Composite Conductive Component and Method for Making it

(76) Inventor: Sören Kahl, Finspang (SE)

(21) Appl. No.: 13/516,107

(22) PCT Filed: Dec. 3, 2010
(86) PCT No.: PCT/SE2010/051335

§ 371 Date: Aug. 7, 2012

Related U.S. Application Data
(60) Provisional application No. 61/314,192, filed on Mar. 16, 2010.

(30) Foreign Application Priority Data
Dec. 16, 2009 (SE) 0950966-2

(51) Int. Cl. H01B 13/00; H01B 5/00; B23K 20/12; B23K 20/04; B23K 1/00

(52) U.S. Cl. 174/126.2; 228/115; 228/158; 228/112.1; 228/117

(57) ABSTRACT

A method of manufacturing a composite conductive component comprising the steps of providing at least two blanks of metallic material, said blanks consisting of dissimilar metallic materials; placing said blanks in edge to edge or in partially overlapping relationship with one another, solid state joining said blanks to each other, by rolling or welding, so as to form a composite body, rolling said composite body along the joint over the entire width of the composite body to reduce the thickness thereof, and cutting the rolled composite body across the joint to produce at least two composite conductive components, each comprising the metallic materials of said at least two blanks and having a joint between said at least two different metallic materials. A composite conductive component comprises at least a first portion of a first metallic material and at least a second portion of a second metallic material, said first and second metallic materials being dissimilar from each other is produced by the method. An electrical connector or conductor or a device for heat conduction comprises the composite conductive component.

### TECHNICAL FIELD

The present invention relates to a method of manufacturing a composite conductive component, to a composite conductive component produced by the method, and electrical contacts or connectors made from the composite material. The invention also relates to electrical and thermal devices comprising the composite material strips.

### BACKGROUND

There are many industrial applications in which joining of copper to aluminium is required. For example in the context of conduction of electric current in equipment where aluminium conductors are to be connected to copper conductors, it is common to use connectors that comprise a copper alloy on one side and an aluminium alloy on the other side. In such connectors the copper side of the connector is mated or joined with the copper conductor and the aluminium side of the connector with the aluminium conductor. The copper part and the aluminium part of the connector are usually joined by a solid state welding method, such as friction welding or hot-press welding, see e g CA 1016255 (A1) and GB 1331468. Other solid state welding techniques such as explosion welding or cold roll bonding also create good aluminium-to-copper joints. In electrical power transmission, large connectors are used and the relative cost of welding materials to each other is therefore not so important. However, replacement of copper conductors by aluminium conductors is being desired both in electrical power transmission and in other applications, such as automotive applications. In such cases, a large number of aluminium-to-copper connectors will be required. Also in Li-ion batteries composed of many separate battery cells electrical connections between copper and aluminium plates are required. Such batteries are of interest in particular for electrically driven vehicles. Electrical connectors that consist of two different metals are typically manufactured by joining small pieces of different metallic materials. With friction welding, the most commonly used technique for electric aluminium-to-copper connectors, a separate welding operation is required for each connector.

Also for applications within thermal conduction, devices that combine copper and aluminium are of interest and have been suggested in TW 429191, where a copper disc is attached to an extruded aluminium heat sink by means of friction welding, in order to have material of maximum possible heat conduction in the direct vicinity of the location to be cooled or heated.

In the above mentioned welding technologies of friction and explosion welding, the parts to be joined need to be moved themselves, which is disadvantageous and costly and sometimes simply impossible for large parts. Hot-press welding or diffusion welding suffer from similar disadvantages due to the fact that the parts to be joined need to be heated.

Hot-press welding or diffusion welding at too high temperatures and fusion welding methods are not suitable for joining aluminium to copper since large volumes of brittle intermetallic phases form in the joint and deteriorate its mechanical properties.

Dissimilar metals, such as copper and aluminium, may also be joined by friction stir welding, which is described e.g. in EP0615480.

However, such friction stir welds are disadvantageous as they often comprise imperfections such as voids, and always comprise small volumes of intermetallic phases, both of which may reduce the static mechanical strength of the joint. Both imperfections and volumes of intermetallic phases are also expected to severely reduce the fatigue strength since they act as stress raisers and therefore reduce the time required for initiation of fatigue cracks. In addition, welding tools for friction stir welding of aluminium to copper currently have a short lifetime due to contamination of the tool.

### SUMMARY OF THE INVENTION

The present invention aims at providing method for manufacturing a composite conductive component that overcomes the disadvantages of the prior art and that may be used to form electrical or thermal conductors in an inexpensive way. This is achieved by the method of the present invention, which provides a method by means of which composite materials with improved joint quality can be obtained, as well as efficient manufacture of high quality composite conductive components.

The method of manufacturing a composite conductive component of the present inventions comprises the steps of providing at least two blanks of metallic material, said blanks consisting of dissimilar metallic materials; placing said blanks in edge to edge or in partially overlapping relationship with one another, solid state joining said blanks to each other, by rolling or welding, so as to form a composite body, rolling said composite body along the joint over the entire width of the composite body to reduce the thickness thereof, and cutting the rolled composite body across the joint to produce at least two composite conductive components, each comprising the metallic materials of said at least two blanks and having a joint between said at least two different metallic materials. The method allows for joining blanks which are made from metallic materials that exhibit a tendency to form brittle compounds when joined to each other at elevated temperatures. A case of particular interest is when the at least two blanks consist of copper or a copper alloy and an aluminium or an aluminium alloy, respectively, and are preferably joined by friction stir welding before rolling. Each blank may be provided with an extension along its longitudinal edge, said extension having a thickness which is lower than the thickness of the blank, and that the blanks are placed in mating overlapping relationship so as to form a lap joint.

If desired the method may include producing a first composite body and a second composite body, and placing said second composite body on said first composite body; and rolling said first and second composite bodies to reduce the thickness thereof. The composite bodies are advantageously placed in an overlapping position such that the joints are mutually displaced. The composite body may also be assembled with a plate or a blank of metal or metal alloy before rolling. The rolling step may comprise hot rolling followed by cold rolling, or cold rolling in two steps, with annealing between the two cold rolling steps.

The invention also relates to a composite conductive component comprising a first portion of a first metallic material and a second portion of a second metallic material, said first and second metallic materials being dissimilar from each other, where the component is produced by the above method. The first and second portions may be made from metallic materials that exhibit a strong tendency to form brittle compounds when joined to each other at elevated temperatures, such as at least one portion being made of copper or one of its alloys, and at least one other portion being made of aluminium or one of its alloys.

The invention also relates to an electrical connector comprising the above composite conductive component, to an electrical conductor comprising the composite conductive component, and to a device for heat conduction comprising the composite conductive component.

### BRIEF DESCRIPTION OF THE DRAWINGS

FIG. 1 shows a sheet comprising two dissimilar materials welded to each other after rolling across the joint.

FIG. 2 shows a composite conductive component obtained by the method according to the invention, consisting of two dissimilar metallic materials.

FIG. 3 shows a composite material before rolling, where two composite bodies have been placed on each other with a mutual displacement of the joints.

FIG. 4 shows two blanks having extensions adapted for forming a lap joint, and being arranged in overlapping relationship.

FIG. 5 shows two blanks having extensions adapted for forming a lap joint, and being arranged in overlapping relationship, where the extensions have an engaging mating shape. FIG. 6 shows an optical microscope image of a friction stir welded joint between aluminium and copper plates after welding, but before rolling.

FIG. 7 shows an optical microscope image of the joint in FIG. 6 after cold rolling of the joint.

### DETAILED DESCRIPTION OF THE INVENTION

The present invention provides a method of producing a composite conductive component formed by joining at least two blanks of dissimilar metallic materials. The present invention also provides a composite material produced by the above method, as well as an electric conductor, an electric connector, and a device for heat conduction comprising a composite conductive component according to the method of the invention.

The method comprises the steps of

a) providing at least two blanks of metallic material, said blanks consisting of dissimilar metallic materials,

b) placing said blanks in edge to edge or in partially overlapping relationship with one another,

c) solid state joining said blanks to each other, by rolling or welding, so as to form a composite body,

d) rolling said composite body along the joint over the entire width of the composite body to reduce the thickness thereof,

e) cutting the rolled composite body across the joint to produce at least two composite components each comprising the metallic materials of said at least two blanks and having a joint between said at least two different metallic materials consisting of at least two different metallic materials.

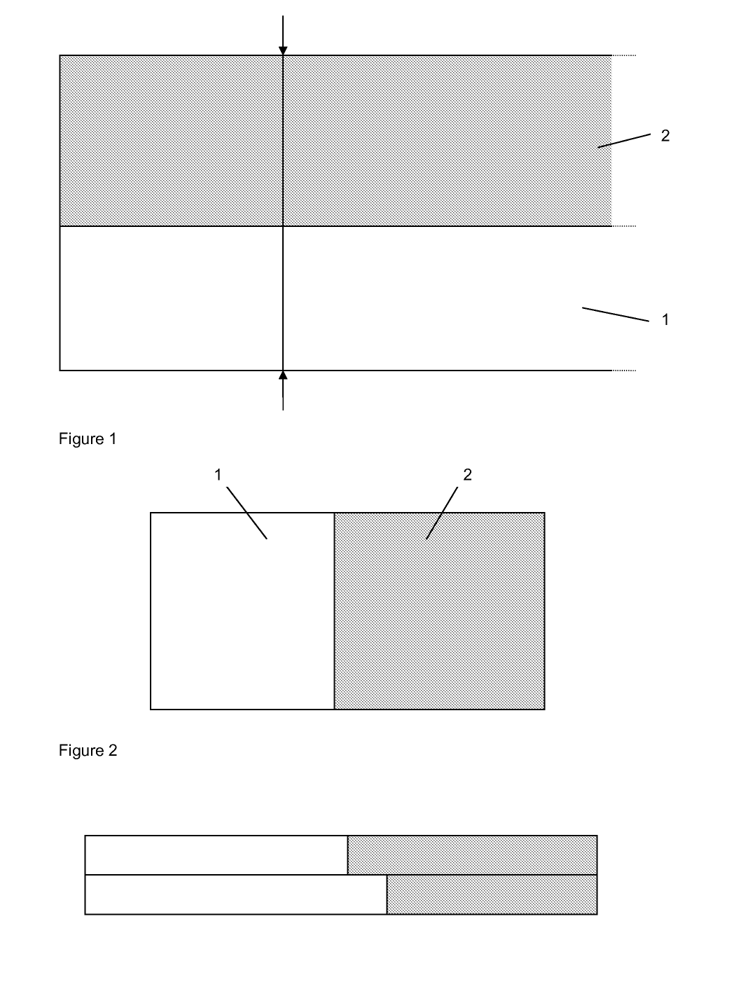

FIG. 1 shows a sheet of copper 1 welded to aluminium 2 which was then rolled across the joint. The arrows indicate the location of the cut to form a copper aluminium composite strip. FIG. 2 shows a composite conductive component according to the invention, consisting of two dissimilar metallic materials.

The blanks are placed adjacent to each other such that they can be joined edge to edge by forming a butt joint, or they can be placed partially overlapping such that a lap joint is formed. In the case of forming a lap joint, each blank is preferably provided with an extension along its longitudinal edge, said extension having a thickness which is lower than the thickness of the blank, and that the blanks are placed in mating overlapping relationship in step b), as is shown FIGS. 4 and 5. By providing extensions that are inversely corresponding to each other, a single plane overlapping joint is formed, which is advantageous when joining the blanks by rolling. The thickness of the extensions of each blank may be the same or different. By providing extensions having an engaging mating shape, for example as the one illustrated in FIG. 5, the blanks can be provisionally held together, thereby facilitating the joining by rolling or welding of the joint.

The above method is particularly suitable for joining blanks made from dissimilar metallic materials that exhibit a tendency to form brittle compounds when joined to each other at elevated temperatures, such as of copper or copper alloys to blanks of aluminium or aluminium alloys. The blanks may be in form of billets or plates or strips. In some applications the blank may be rolled before joining. The blanks may also be in the form of billets or thick plates. When thick blanks are used, the length of the joint before rolling will be comparatively short. This may be advantageous from an economical point of view, in particular when joining the blanks by welding, since welding is a comparatively expensive process. The blanks are then rolled to the final thickness, thus elongating the weld joint. Rolling of a weld joint has been found to result in a stronger joint. Also, when the blanks are joined by rolling without welding, joining blanks in the form of billets or thick plates by rolling to a considerable thickness reduction will result in an improved joint as compared to joining already rolled blanks by further rolling.

In case the composite body is formed by rolling in step c) the rolling of steps c) and d) can be performed directly after each other, or as one operation.

By joining the blanks by using a solid state welding method and cold rolling over the entire width of the composite body so formed, an improved joint quality is obtained even when the dissimilar metals have a tendency to form brittle intermetallic compounds when joined at elevated temperatures, involving that the materials are partially molten (which may happen when fusion welding techniques are used) or at least very close to their respective melting temperatures such that diffusion across the interface between the dissimilar metals is strongly enhanced. By using the method of the invention the quality of the interface(s) between the dissimilar metals is very high, the interface will be substantially free from pores, and where any intermetallic phases exist, these are small and scattered, such that the weld joint exhibits both high static mechanical strength and high fatigue strength. In addition to providing an improved joint quality, the costs of production are significantly lower than for methods currently available.

In order to obtain a joint of high quality, the blanks should preferably be joined by a welding method which forms a weld that is ductile enough to allow rolling of the weld joint. In the present invention the plates of dissimilar metals are preferably welded together by friction stir welding. A friction stir weld joint is much stronger than joints obtained by fusion welding techniques between metals that form brittle intermetallic phases at elevated temperatures, such as joints formed between e.g. copper or a copper alloy and aluminium or an aluminium alloy. However, the friction stir weld joint may still contain imperfections and is mechanically weaker than the parent materials. A method for friction stir welding of metallic materials is described e.g. in EP0615480. It has been found that the strength and ductility of a friction stir weld allow for strong cold rolling reductions without fracture of the joint. In fact, by friction stir welding copper to an aluminium alloy and cold rolling the so formed composite body the joint will even be more ductile than one of the parent materials. During rolling, any pores present in the friction stir weld joint are substantially eliminated, and any intermetallic phases will become small and scattered, thus considerably increasing the quality of the joint.

For combinations of dissimilar metallic materials, which have a strong tendency to form brittle intermetallic compounds at elevated temperatures, such as copper or a copper alloy and aluminium or an aluminium alloy, a welding method is needed that does not form a joint which is more brittle than the rest of the composite material, since there would be a risk that such a weld joint would fracture during rolling. Most other welding methods would not form joints strong and ductile enough to permit rolling across the joint to reduce the thickness to a thin strip.

During cold rolling, the joint is strengthened by deformation hardening, the pores present after friction stir welding are closed, and potentially present thin layers of intermetallic phases are broken down and dispersed. Due to deformation hardening during cold rolling, the tensile strength of the composite conductive component after cold rolling can be much higher than the tensile strengths of the two separate materials prior to friction stir welding and cold rolling.

Production costs are in many cases dominated by the cost for creating the joint between the dissimilar metals, especially if the lifetime of the friction stir welding tool is very short. By cold rolling after friction stir welding, the length of joint may be increased by a factor of 10 or more, such that the wear of the friction stir welding tool per meter produced joint is reduced, which significantly reduces the production costs of the composite material strip.

The gain in length, i.e. the reduction of the thickness of the material after the solid state joining process of step c) can be increased even further if cold rolling is preceded by hot rolling at moderate temperatures, preferably below 350° C. in the case of copper or copper alloys and aluminium or aluminium alloys or if the material is annealed between cold rolling steps. By intermediate annealing at moderate temperature, preferably below 350° C. in the case of copper or copper alloys and aluminium or aluminium alloys between sets of cold rolling steps, the ductility can be restored such that large degrees of rolling deformation may be achieved.

Subsequent to rolling to the desired final thickness, the rolled composite body is cut across the joint so as to form composite conductive components comprising portions of both dissimilar metallic materials and a joint between these materials. The cut may be placed perpendicularly to the joint of the rolled composite body, or in any desired angle thereto.

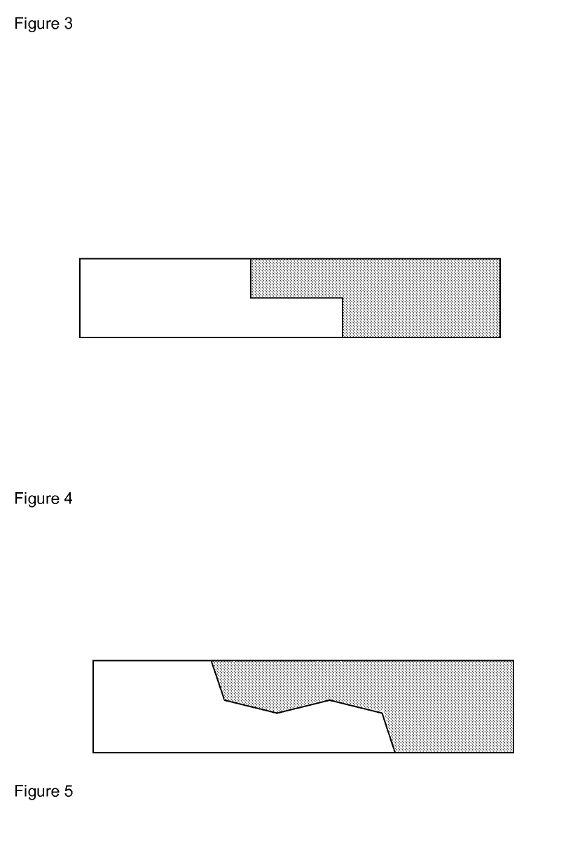

It may be desired to obtain a composite conductive material comprising two or more layers of metallic materials on top of each other. The method of manufacturing composite conductive components may thus include producing a first composite body by performing steps a) to c) above, and producing a second composite body by performing steps a) to c) above, and placing said second composite body on said first composite body; followed by rolling said first and second composite bodies according to step d) to reduce the thickness thereof. FIG. 3 shows a composite material before rolling, where two composite bodies have been placed on each other with a mutual displacement of the joints. In FIG. 3, the joints are shown as butt joints, but lap joint can of course also be placed in this way.

Stacking of composite bodies may be advantageous when the desired final thickness requires an initial blank thickness that is beyond the maximum thickness which can be welded by means of friction stir welding. Thus two or more welded composite bodies can be assembled e.g. by stacking them prior to the rolling step. If the interfaces are clean, the stacked plates will be bonded to each other during rolling. A step of cleaning the surface of the composite body can be included if necessary. By arranging the composite bodies so that the joints between the dissimilar metallic materials are mutually displaced will result in a stronger material after rolling.

Stacking plates or composite bodies prior to rolling, where at least one plate comprises a friction stir weld, may also be advantageous, since it would allow for the production of new composite materials.

The composite body may also be assembled with a metal or metal alloy plate that may be placed on or under the composite body produced in the above method before rolling, and thus be assembled to the composite body by rolling. Also several composite bodies and/or metal plates may be stacked, preferably so that the joints are mutually displaced in order for the weld lines not to overlap, in which way a stronger material will result after rolling.

The rolling step d) of the method may alternatively comprise hot rolling followed by cold rolling, or cold rolling in two steps, with annealing between the two cold rolling steps. Thereby, the total possible thickness reduction is increased, since the ductility is higher during hot rolling, as compared to cold rolling. Intermediate annealing restores the ductility, such that additional rolling can be performed.

After joining and rolling the rolled composite body is cut across the joint to produce at least two composite components each comprising the metallic materials of said at least two blanks and having a joint between said at least two different metallic materials consisting of at least two different metallic materials. The composite components can e.g. be cut from the rolled composite body as strips having width of the intended final component, or can be stamped out from the rolled composite body or from smaller pieces thereof. Thus by joining and rolling blanks of dissimilar metals and cutting the rolled composite body, an improved method of manufacturing conductive composite components can be achieved, which components also have an improved joint quality between the dissimilar metals.

The composite conductive components obtained may be used for electric connectors or conductors in electric appliances or for automotive applications, such as for electric connections of cables or magnetic coils, or in battery cells for electric cars.

Especially for electric connectors, it may be required to coat at least parts of the composite conductive component with a thin layer of a different material such as tin, silver or another metal that improves the contact resistance and reduces the risk for contact failure, e.g. due to fretting. This is common in the production of electrical connectors and would preferably be done after rolling as described in step d).

The composite conductive components obtained may also be used for devices based on heat conduction, such as systems to cool power electronics.

In cooling of electronics such as automotive electronics, e.g. cooling of single high-power integrated circuits on printed circuit boards placed inside pressure-moulded aluminium housings, aluminium-copper composite material in the form of a strip or sheet could be applied. Copper would then be in contact with the integrated circuit and aluminium material would be joined to the housing.

Other applications could also be envisaged.

### EXAMPLE

Plates made of Aluminium AA6063-T6 and phosphorous-deoxidized copper (high residual phosphorous) were joined by friction stir welding. FIG. 6 shows the friction stir welded joint between aluminium and copper plates. Although a joint of good quality was obtained; it however still contained pores as shown at the arrow in FIG. 6.

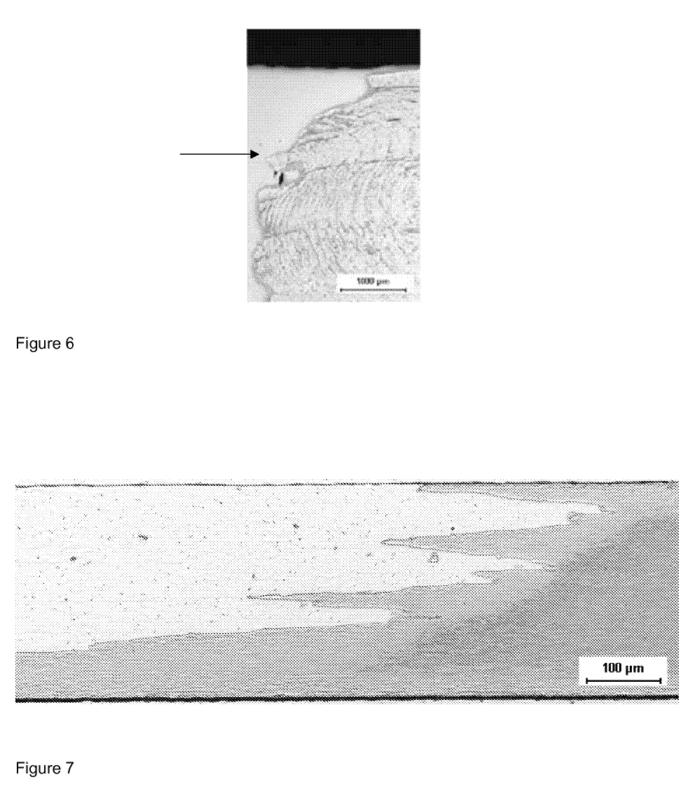

Starting from plates of 3 mm thickness, the Al—Cu composite sheet was cold rolled down to 0.3 mm thickness. FIG. 7 shows the joint in FIG. 4 after cold rolling of the joint. The pores were closed entirely, as can be seen in FIG. 7, and the Al—Cu interfacial area was very large as compared to the sheet thickness, which created a strong bond.

At the same time, the surface finish of the joint was excellent, with a clear linear transition from aluminium to copper.

The tensile strength of the composite material exceeded those of the parent materials prior to friction stir welding and cold rolling, see the following table.

| Material | Tensile strength |
|---|---|
| Aluminium AA6063-T6, prior to friction stir welding | 245 MPa |
| Phosphorous-deoxidized copper, prior to friction to stir | 235 MPa |
| welding | |
| Aluminium-Copper composite material, | 335 MPa |
| after friction stir welding of the above two materials | |
| (butt joint, no overlapping parts) | |
| and cold rolling from 3 mm to 0.3 mm | |

After cold rolling with 90% reduction in thickness, both materials soften at 300° C., which makes possible intermediate annealing without excessive growth of brittle intermetallic particles.

1. A method of manufacturing a composite conductive component comprising the steps of
a) providing at least two blanks of metallic material, said blanks consisting of dissimilar metallic materials,
b) placing said blanks in edge to edge or in partially overlapping relationship with one another,
c) solid state joining said blanks to each other, by rolling or welding, so as to form a composite body,
d) rolling said composite body along the joint over the entire width of the composite body to reduce the thickness thereof, and
e) cutting the rolled composite body across the joint to produce at least two composite conductive components, each comprising the metallic materials of said at least two blanks and having a joint between said at least two different metallic materials.

2. The method of claim 1, wherein said at least two blanks are made from dissimilar metallic materials that exhibit a strong tendency to form brittle compounds when joined to each other at elevated temperatures.

3. The method of claim 2 wherein said at least two blanks consist of copper or a copper alloy and aluminium or an aluminium alloy, respectively.

4. The method of claim 1, wherein the blanks are joined in step c) by friction stir welding.

5. The method of claim 1, wherein each blank is provided with an extension along its longitudinal edge, said extension having a thickness which is lower than the thickness of the blank, and that the blanks are placed in mating overlapping relationship in step b) so as to form a lap joint.

6. The method of claim 1, comprising producing a first composite body by performing steps a) to c), and producing a second composite body by performing steps a) to c), and placing said second composite body on said first composite body; and rolling said first and second composite bodies according to step d) to reduce the thickness thereof.

7. The method of claim 6, wherein the composite bodies are placed in an overlapping position such that the joints are mutually displaced.

8. The method of claim 1, wherein the composite body produced in step c) is assembled with a plate or a blank of metal or metal alloy before rolling according to step d).

9. The method of claim 1, wherein the rolling step d) comprises hot rolling followed by cold rolling, or cold rolling in two steps, with annealing between the two cold rolling steps.

10. A composite conductive component comprising at least a first portion of a first metallic material and at least a second portion of a second metallic material, said first and second metallic materials being dissimilar from each other, wherein the component is produced by the method of claim 1.

11. The composite conductive component of claim 10, wherein said at least first and second portions are made from metallic materials that exhibit a strong tendency to form brittle compounds when joined to each other at elevated temperatures.

12. The composite conductive component of claim 10, wherein at least one portion is made of copper or one of its alloys, and at least one other portion is made of aluminium or one of its alloys.

13. An electrical connector comprising a composite conductive component of claim 10.

14. An electrical conductor comprising the composite conductive component of claim 10.

15. A device for heat conduction comprising the composite conductive component of claim 10.
